(19) United States
(12) Patent Application Publication
(10) Pub. No.: US 2023/0418331 A1
(43) Pub. Date: Dec. 28, 2023

(54) Auxiliary Display System

(71) Applicants: Rachel Matheson, Pearland, TX (US); Alexander Matheson, Pearland, TX (US)

(72) Inventors: Rachel Matheson, Pearland, TX (US); Alexander Matheson, Pearland, TX (US)

(21) Appl. No.: 18/152,291

(22) Filed: Jan. 10, 2023

Related U.S. Application Data
(60) Provisional application No. 63/355,125, filed on Jun. 24, 2022.

(51) Int. Cl. G06F 1/16; F16M 11/28

(52) U.S. Cl. CPC G06F 1/1637; G06F 1/1632; F16M 11/28

(57) ABSTRACT

The present invention relates to a novel transportable auxiliary display system. The mobile monitor, screen, or display is provided for use with a laptop or other electronic device to offer a second monitor for multitasking while traveling. The monitor may connect to the laptop or other electronic device through a docking station which is provided with an enclosure and a cord. The monitor or display can expand upward through the docking station and unfold to reveal a full, second computer monitor. The invention will provide the user with one or multiple extra monitors to combine with their device when traveling. The auxiliary display can be used as needed to complete work, and then retract into the enclosure or docking station when no longer needed.

### CROSS-REFERENCE TO RELATED APPLICATION

The present application claims priority to, and the benefit of, U.S. Provisional Application No. 63/355,125, which was filed on Jun. 24, 2022 and is incorporated herein by reference in its entirety.

### FIELD OF THE INVENTION

The present invention relates generally to the field of monitors, displays and screens. More specifically, the present invention relates to a transportable expanding monitor system that provides users with a second monitor or display when used in conjunction with a laptop or other electronic device where the user may desire to view the displayed information on a larger or additional screen. Accordingly, the present disclosure makes specific reference thereto. Nonetheless, it is to be appreciated that aspects of the present invention are also equally applicable to other like applications, devices, and methods of manufacture.

### BACKGROUND

By way of background, the present invention relates to improvements in the field of monitors, screens, and displays for use with electronic devices that are capable of rendering, transmitting, or displaying an image. Specifically, mobile monitors or displays that are able to be collapsed for storage or transported while traveling. This device is generally desired in the art to make the experience of working on a laptop while traveling more productive. While working in a home or office setting, people may be accustomed to using multiple monitors or other displays. Dual monitors can improve multitasking as it allows for simultaneous viewing of multiple files, folders, programs, emails, and other content. Traveling with a second traditional monitor or display is difficult, as the monitors or displays are not typically designed to be used away from a desktop or other workstation. Mobile monitors are collapsible and lightweight, designed for use with a laptop or other electronic device while traveling or away from the home or office.

Specifically, the present invention is a monitor or display that is for use with a laptop or other computer while traveling or working outside of the traditional workspace and thereby, provides a second monitor or display for enhanced multitasking or other activity where it may be helpful to have more than one screen or display. The monitor may connect to the laptop through a docking station with a cord or may be wireless such as a Bluetooth connection. The monitor or display can be expanded upwardly through the docking station and expanded to reveal a full, second monitor for a laptop or other electronic device. The invention will essentially provide the user with one or multiple additional monitors or screens to use with their laptop or other device when traveling or away from the home, office, or other workspace. The second monitor or screen can be used as needed to complete work, studying, watching various media types, entertainment, or other activities and then retract into the docking station or carrying case when the task(s) or activities are completed. The docking station or carrying case can be transported with ease due to its lightweight structure.

Therefore, there exists a long-felt need in the art for a monitor or auxiliary display system that allows users to take a second monitor, display, or screen with them while traveling or being outdoors while away from the home, office, or workstation. There is also a long-felt need in the art for a monitor, display, or screen with a docking station that can be connected to a laptop or other electronic device. Finally, there is a long-felt need in the art for a computer monitor system that can be easily collapsed and expanded.

The subject matter disclosed and claimed herein, in one embodiment thereof, comprises an auxiliary monitor, display, or screen system. The device is designed for use with a laptop or other electronic device while traveling. The monitor, screen or display may connect to the laptop or electronic device through a docking station and a cord or other methods such as wirelessly. The monitor or display can be raised or expanded upwardly through the docking station or carrying case and expand to reveal a full, second monitor or display for a laptop or other electronic device, such as a tablet or phone. The second monitor can be used as needed to complete work, studying, provide entertainment, or engage in other tasks or activities and then retract into the docking station or carrying case when the task(s) or activities are completed. The docking station can be transported with ease due to its lightweight and compact structure.

In this manner, the auxiliary display system of the present invention accomplishes all of the foregoing objectives and provide users with an additional monitor, screen or display that is easily transportable. The device is particularly useful for people who are accustomed to using multiple monitors, screens or other displays while completing their tasks.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an auxiliary display system which is highly transportable and mobile. The device is compact and presented in a convenient and transportable format to provide users with a secondary monitor or display while traveling. The device includes a docking station with a telescopic neck that extends upwardly from a base. At the top of the telescopic neck is a foldable monitor, display, or screen. When in use, the neck is extended with the monitor or screen in a first position, such as an unfolded configuration. The docking station has a cord that allows the user to connect the auxiliary screen to a laptop or other electronic equipment. Once extended to the desired position, the screen or display is then unfolded to its second or open position so that it is ready for use.

When the auxiliary display system is not in use, the monitor, screen, or display is folded, and the telescopic neck is contracted or compressed downwardly into the docking station and storage case for storage, transport, or travel. This docking station is compact and lightweight, making the auxiliary display system easy to carry in a backpack, briefcase, or by hand.

In one embodiment, the docking station has an HDMI cord that plugs into an HDMI port on a laptop or other electronic device to connect the two devices and enable the auxiliary display system or mobile monitor to be used. The exact size, measurement, construction, and design specifications regarding the docking station may vary depending on the electronic device with which it is intended to be used as well as economics and manufacturing.

In one embodiment, the docking station features a power cord that connects to a wall outlet.

In one potential embodiment, the docking station features a generally rectangular slot that allows the telescopic neck and foldable monitor to collapse within the docking station or storage case, allowing a sleek and compact design.

In another potential embodiment, the docking station includes an external handle that allows for easy transportation, handling, and storage.

In another potential embodiment, the docking station includes wheels on the bottom of the storage case for easy adjustment or transportation.

In another embodiment, the docking station features USB ports for the charging a mobile phone or other electronic devices.

In yet another potential embodiment, the docking station includes a storage compartment to store a mouse, notepad, or other useful and personal items.

In one embodiment, the docking station may be manufactured from metal, heat-sealable plastic or polymer, such as polypropylene or acrylonitrile-butadiene-styrene (ABS), or any material known in the art deemed suitable for the described purpose.

In yet another embodiment, the docking station includes a plurality of indicia and graphics.

In another embodiment the auxiliary display system may be wirelessly connected to the electronic device which it is to be used with or alternatively, to a network which allows the laptop or computer to connect to the auxiliary display system via the network.

In one embodiment, the telescopic neck is generally rectangular in terms of its cross section for compactness. The rectangular design of the telescopic neck allows for the monitor, display, or screen and the neck itself to fit completely down into the slot of the docking station or carrying case. The rectangular design of the telescopic neck also allows for more stability as opposed to a cylindrical design. Exact size, measurement, construction, and design specifications may vary upon further development and manufacturing.

In one potential embodiment, the telescopic neck is segmented so that the thinnest segment is at the top connected to the monitor, and the widest section is at the bottom connected to the interior of the docking station. This allows the smallest segment to fit or nest within the adjacent section beneath, and so on and so forth, to fully collapse or nest within the neck assembly.

In another potential embodiment, a cord may extend through the telescopic neck up into the bottom of the monitor to allow the signal from the laptop, computer, or other electronic device to run to the docking station via the telescopic neck, and to the monitor, thereby creating a seamless design.

In one embodiment, the cord connecting the docking station to the monitor is external to the telescopic neck.

In yet another embodiment, the telescopic neck of the present invention is manufactured from heat-sealable plastic or polymer, such as polypropylene or acrylonitrile-butadiene-styrene (ABS), aluminum, stainless steel, or any other material deemed suitable for the purpose described.

In yet another embodiment, the telescopic neck includes a plurality of indicia, graphics, or combinations thereof.

In a further embodiment, a combination electronic device and auxiliary screen system is provided that comprises an electronic device selected from a table, laptop, computer, television, smartphone, or combination thereof, and an enclosure having a foldable screen or display for connection to the electronic device.

In another embodiment, the monitor, screen, or display is foldable upon itself in a tri-fold fashion with the screen having a central portion and left and right portions, with the left and right portions folding over the central portion. In an alternate configuration, the screen may have a bi-folded configuration and be folded in half. This allows the monitor to become more compact and fit within the slot of the docking station.

In yet another potential embodiment, the monitor features a power button and other adjustment buttons to customize the monitor's display depending on the preference or needs of the user.

In yet another embodiment, the monitor includes USB ports to allow for the charging of a mobile phone or other devices.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the auxiliary display system or mobile monitor of the present invention with the telescopic neck extended and the monitor, screen, or display expanded for easy viewing, complete with a power cord running from the docking station in accordance with the disclosed architecture;

FIG. 2 illustrates a perspective view of the various stages of the process of extending one potential embodiment of the telescopic neck and unfolding of the monitor, display, or screen of the present invention in accordance with the disclosed architecture;

FIG. 3 illustrates a perspective view of one potential embodiment of the foldable monitor, screen or display of the present invention, complete with an HDMI port, a USB port, and buttons in accordance with the disclosed architecture

FIG. 4 illustrates a perspective view of one potential embodiment of the mobile monitor of the present invention in accordance with the disclosed architecture being used in conjunction with a laptop or computer;

FIG. 5 illustrates a perspective view of one potential embodiment of the auxiliary display system or mobile monitor of the present invention in its fully collapsed state, showing the compact and lightweight design such that it may be transported in a backpack along with a laptop;

FIG. 6A illustrates a perspective view of one potential embodiment of the enclosure for the collapsible monitor, screen, or display of the present invention in accordance with the disclosed architecture; and

FIG. 6B illustrates a top view of one potential embodiment of the enclosure and showing the slot which opens the cavity for holding the monitor, display, or screen in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an auxiliary display system that allows users to take a second monitor, display, or screen with them while traveling or away from the office, home, or workstation. There is also a long-felt need in the art for an auxiliary display system or mobile monitor with a docking station that can be connected to a laptop or other electronic device, such as a tablet, phone, television, medical equipment, or computer. Finally, there is a long-felt need in the art for a computer monitor system that can be easily collapsed or expanded.

The present invention, in one exemplary embodiment, is a novel auxiliary display system or mobile monitor. The auxiliary display system is a monitor, display, or screen system for use with a laptop or other electronic device while traveling or engaging in other activities where an additional screen would be useful, offering a second monitor for enhanced multitasking, entertainment, or other activities. The monitor may connect to the electronic device through a docking station, a cord or alternatively, the electronic device can connect wirelessly directly to the electronic device or to the device via a network to which the monitor or screen was previously connected to. The monitor, screen, or display can expand upward through the docking station or storage case and expand to reveal a full, second monitor, screen, or display for a laptop or other electronic device. The invention will provide the user with one or multiple extra monitors, screens, or displays to combine with their laptop or other electronic device when traveling or when an additional screen or display would facilitate or enhance the activity in which the individual is engaged. The second monitor, screen or display can be used as needed to complete work, studying, provide entertainment or other tasks and then retract into the docking station when the task(s) is completed. The docking station can be transported with ease due to its lightweight, convenient, and compact structure.

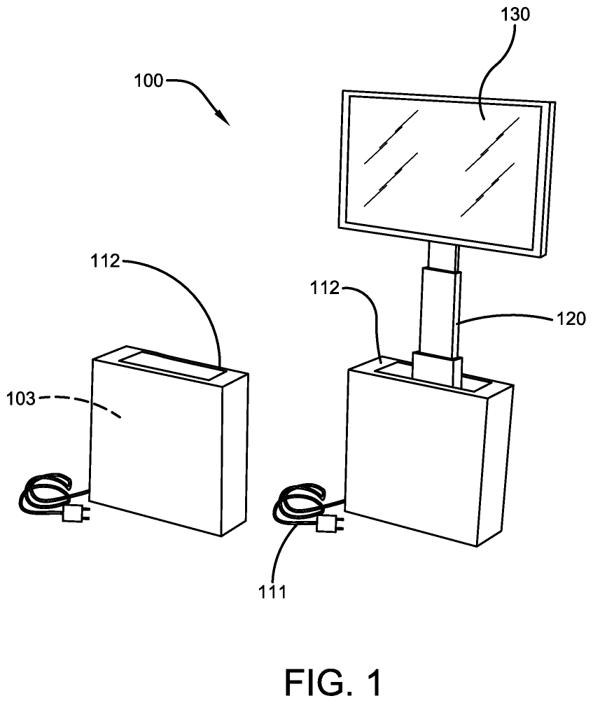

Referring initially to the drawings, FIG. 1 illustrates a perspective view of one embodiment of the auxiliary display system or mobile monitor 100. In the present embodiment, the auxiliary display system or mobile monitor 100 is a transportable and convenient monitor, screen, or display system. The device 100 is particularly designed to allow for easy transportation due to its compact and lightweight attributes. More specifically, the device 100 includes a docking station 110, telescopic neck 120, and a foldable monitor 130. FIG. 1 illustrates the device 100 both in fully contracted and fully expanded configurations, wherein the movement between the two configurations is substantially linear.

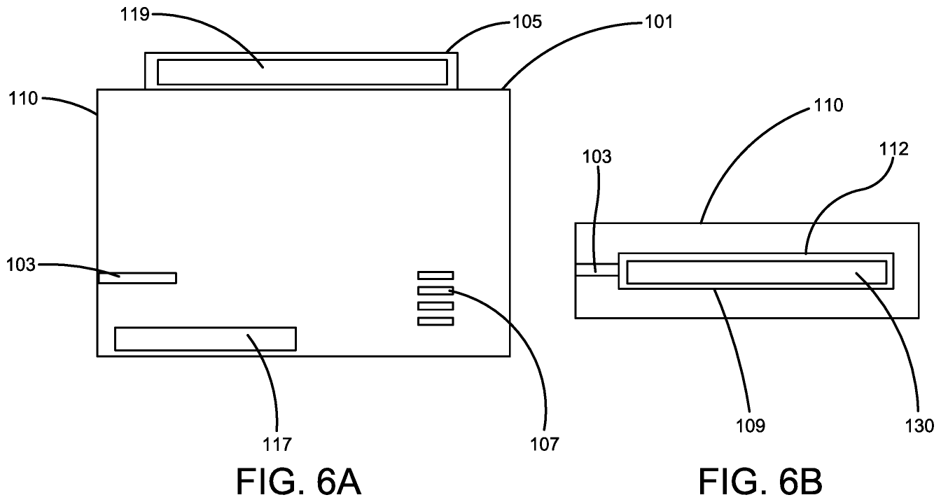

The docking station or enclosure 110 includes a power cord 111 that connects to a standard wall outlet or other electric port that can be used to provide power to the station 110. The docking station may also be housed within the enclosure 110 and may further comprise a battery. The docking station or enclosure with a docking station housed within the enclosure 110 features a slot 112 on the top side that allows the telescopic neck 120 and foldable monitor 130 to be fully contracted within. The enclosure 110 may also comprise a lock 103 located in the bottom or sides of the enclosure 110 to prevent the foldable monitor, display, or screen 130 from expanding from the enclosure when not required. The enclosure 110 has side walls, a base and top wall with a slot 112. The enclosure 110 includes an interior space or cavity 109 (see FIG. 6A) to hold the monitor, display, or screen 130. The slot 112 of the docking station 110 is generally rectangular in shape, although any shape that is deemed suitable for the purpose may be used. The slot 112 has a width ranging from 2″ to about 6″ with about 3′ to 4″ being preferred and a length ranging from about 6″ to 18″ with about 8″ to 12″ being preferred. The docking station 110 also features an HDMI port 113 that allows an HDMI cable 114 to connect to a laptop or other electronic device. Additionally, the docking station 110 features a USB port 115 that allows for the connection of a USB cable 116.

In one embodiment, the docking station or enclosure 110 is manufactured from heat-sealable plastic or polymer, such as polypropylene or acrylonitrile-butadiene-styrene (ABS), aluminum, stainless steel, or any other material deemed suitable for the purpose described.

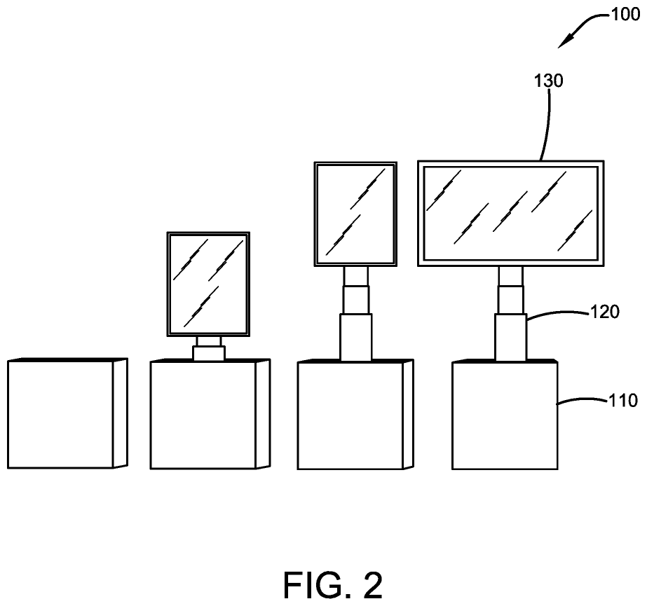

FIG. 2 illustrates a perspective view of one embodiment of the stages of the process of extending the telescopic neck 120 from the docking station or enclosure 110, and unfolding of the foldable monitor or display 130 of the present invention 100. When the device 100 is fully contracted, the telescopic neck 120 and foldable monitor 130 fit entirely within the docking station 110 and the slot 112 can be closed over the top of the display or monitor 130. This is achieved by collapsing the foldable monitor or display 130 and telescopic neck 120 through the slot 112 of the docking station 110. In the fully contracted state, the device 100 is lightweight and compact, allowing for easy storage or transportation while traveling. To expand the device 100, the user extends the telescoping neck 120 and unfolds the foldable monitor 130.

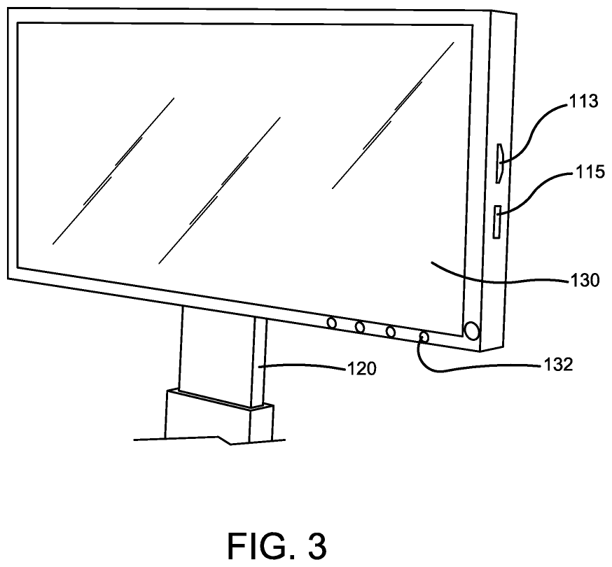

FIG. 3 illustrates a perspective view of the foldable monitor, screen, or display 130 of the present invention 100. The foldable monitor 130 is attached to the telescopic neck 120 and features an HDMI port 113 and a USB port 115. This allows an HDMI cable 114 or USB cable 116 to run from the foldable monitor, screen, or display 130 to the docking station 110, a laptop, or other electronic device. The foldable monitor, screen, or display 130 also features a multitude of buttons 132. The buttons 132 may be used to power the mobile monitor 100 on or off, as well as set other display preferences, e.g., brightness, contrast, color settings, etc. The foldable monitor, screen, or display 130 is able to collapse upon itself in sections so that it can fit through the slot 112 of the docking station 110 for storage or transportation.

In one embodiment, the foldable monitor is a modern thin-film-transistor, liquid-crystal-display with LED backlighting, although any other type of display deemed suitable for the purpose described may be used.

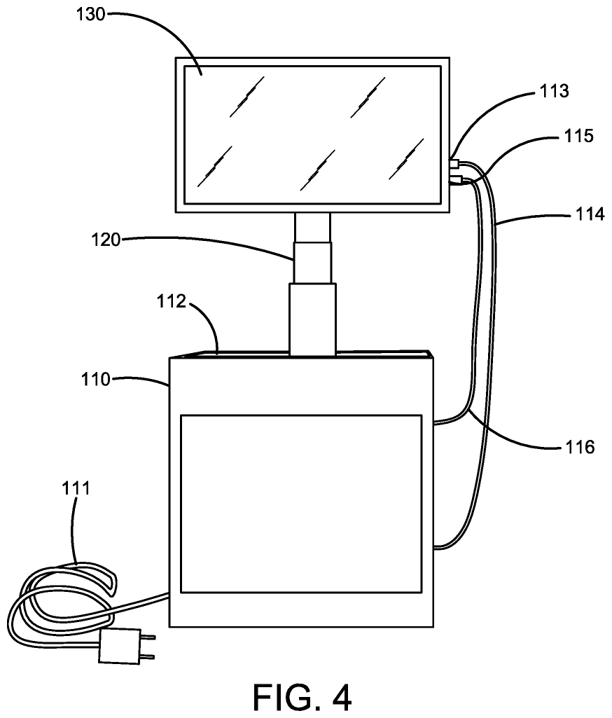

FIG. 4 illustrates a perspective view of one embodiment of the mobile monitor, screen, or display 100 of the present invention in accordance with the disclosed specification being used in conjunction with a laptop. This image shows the connection of the HDMI cable 114 and USB cable 116 from the laptop to the foldable monitor, screen, or display 130.

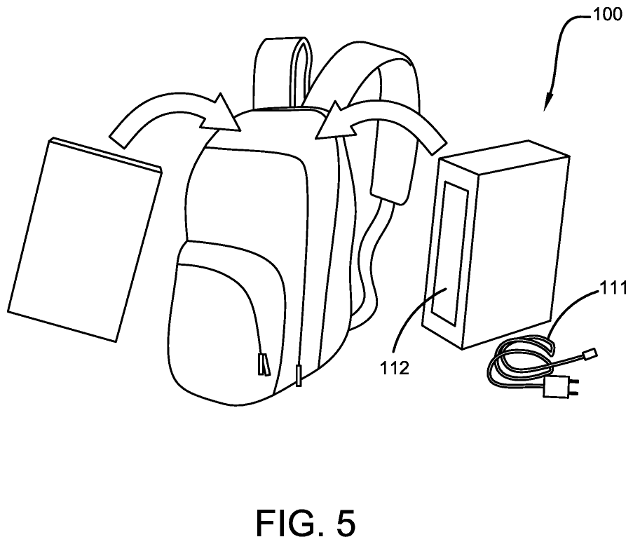

FIG. 5 illustrates a perspective view of one embodiment of the mobile monitor or auxiliary display system 100 of the present invention in its fully collapsed state, showing the compact and lightweight design's ability to be transported in a backpack along with a laptop.

FIG. 6A shows a front view of the enclosure 110 in which a lock 103 is used to hold the monitor, screen, or display within the cavity 109 (FIG. 6B) of the enclosure 110. The enclosure 110 has a top side 101 which has a slot 112 which is covered by a moveable flap 105. The exterior of the enclosure 110 may also include a charge level indicator 107 to show the level of charge in the battery 117 contained within the docking station 110. The battery 117 allows the auxiliary screen to be used when not connected to a power source. The flap 105 may also have a solar panel 119 on an exterior surface of the flap 105 to allow the battery 117 to be charged and to maintain sufficient power for the monitor, display, or screen.

FIG. 6B provides a top view of the enclosure 110 showing the slot 112 which provides egress into the cavity 109 and shows the folded monitor 130 with a width and length less than the width and length of the slot 112. FIG. 6B also shows the lock 103 engaged with the screen, display, or monitor 130 when enclosed within the cavity 109.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “mobile monitor or auxiliary display device” and “device” are interchangeable and refer to the mobile monitor or auxiliary display device 100 of the present invention.

Notwithstanding the foregoing, the mobile monitor or auxiliary display device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the mobile monitor or auxiliary display device 100 as shown in the FIGS. are for illustrative purposes only, and that many other sizes and shapes of the mobile monitor or auxiliary display device 100 are well within the scope of the present disclosure. Although the dimensions of the mobile monitor or auxiliary display device 100 are important design parameters for user convenience, the mobile monitor or auxiliary display device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An auxiliary display system comprising:
an enclosure having side walls, a base and a top;
a cavity positioned in the enclosure;
a slot in the top that provides access to the cavity;
a cord extending from the enclosure; and
a monitor stored within the cavity and repositionable between a contracted position and an expanded position.

2. The auxiliary display system as recited in claim 1 further comprising a lock for holding the monitor within the cavity.

3. The auxiliary display system as recited in claim 1 further comprising a battery contained within the enclosure.

4. The auxiliary display system as recited in claim 1 further comprising a solar panel provided on an exterior surface of the enclosure.

5. The auxiliary display system as recited in claim 3 further comprising a display for showing a charge in the battery.

6. The auxiliary display system as recited in claim 1, wherein the monitor is foldable.

7. The auxiliary display system as recited in claim 6, wherein the monitor is folded in a bi-fold configuration or a tri-fold configuration.

8. The auxiliary display system as recited in claim 7, wherein the monitor comprises a central panel, a right panel and a left panel when the monitor is in the tri-fold configuration.

9. The auxiliary display system as recited in claim 1, wherein the enclosure further comprises a docking station for connection to a laptop.

10. The auxiliary display system as recited in claim 6, wherein the monitor fits within the slot when in a folded condition.

11. The auxiliary display system as recited in claim 1, wherein movement of the monitor from the contracted position to the expanded position is linear.

12. A combination monitor and electronic device comprising:
a docking station;
a monitor that is repositionable between a first position and a second position;
an electronic device connectable to the docking station, wherein the docking station provides an auxiliary display for the electronic device; and
a slot in the docking station that is sized and configured to receive the monitor.

13. The combination monitor and electronic device as recited in claim 12 further comprising a battery.

14. The combination monitor and electronic device as recited in claim 12, wherein the first position is an unfolded position and the second position is a folded position.

15. The combination monitor and electronic device as recited in claim 13, wherein the folded position is one of a bi-fold configuration or a tri-fold configuration.

16. The combination monitor and electronic device as recited in claim 12, wherein the monitor may be connected to the electronic device by a cord or wirelessly.

17. The combination monitor and electronic device as recited in claim 12, wherein the docking station comprises a light indicator.

18. The combination monitor and electronic device as recited in claim 12, wherein the docking station comprises a lock for holding the monitor within the docking station.

19. An enclosure and display combination comprising:
an enclosure having a docking station;
a display provided in a cavity within the enclosure, wherein the display is repositionable between a first position and a second position;
a slot in the enclosure that is sized and configured such that the display may be repositioned in and out of the enclosure;
a cord for connecting the display to a laptop; and
a battery for providing power to the display, wherein the display is foldable.

20. The enclosure and display combination as recited in claim 19, wherein the display is supported on a telescoping neck to extend the display from the first position to the second position.
